(19) United States
(12) Patent Application Publication
(10) Pub. No.: US 2014/0057229 A1
(43) Pub. Date: Feb. 27, 2014

(54) SIMULATOR FOR TRAINING A TEAM, IN PARTICULAR FOR TRAINING A HELICOPTER CREW

(71) Applicant: Volker Groteluschen, Syke (DE)

(72) Inventor: Volker Groteluschen, Syke (DE)

(73) Assignee: Rheinmetall Defence Electronics GmbH, Bremen (DE)

(21) Appl. No.: 13/983,610

(22) PCT Filed: Feb. 15, 2012
(86) PCT No.: PCT/EP2012/052551

§ 371 Date: Nov. 13, 2013

(30) Foreign Application Priority Data
Feb. 22, 2011 (DE) 10 2011 012 018.1

(51) Int. Cl. G09B 9/46; F41A 33/06

(52) U.S. Cl. CPC G09B 9/46; F41A 33/06
USPC 434/18; 434/33

(57) ABSTRACT

The invention relates to a simulator (10) for training at least one person, comprising a training room (20), the inner delimiting surface of which is provided with a color suitable for a color-based picture knock-out, wherein the simulator (10) comprises at least one semi-transparent head-mounted display (21; 21″), which is provided with two video cameras for stereoscopic images and a head tracker, which allows the line of sight of the respective wearer to be ascertained. The simulator (10) further comprises a simulation processor (22) having two picture generators for a stereoscopic representation of virtual pictures on the at least one head-mounted display (21; 21′), and the virtual pictures to be represented can be generated by a video mixer, which comprises means for isochronously mixing the images of the video cameras of the at least one head-mounted display (21, 21′) with computed virtual pictures in the respective line of sight.

The invention relates to a simulator for training at least one person.

It is known that simulators are often used for training persons in teams, whereby the persons to be trained operate in a virtual world. This can be carried out e.g. as for the crews of aircraft, land and sea vehicles. In order to train in the handling of a complex system, a physical replica of the vehicle or aircraft cabin represents a virtual reality on e.g. a spherical projection surrounding it. The size e.g. of a helicopter cabin and the continuously moving viewing points of the crew members result in the necessity to construct a large spherical projection surface of 100° (+10°/−90°)×360°. The diameter can thereby be 8 meters and 12 viewing channels appear to be necessary and realistic. Instruments to be operated are simulated as an MMI (Man-Machine Interface) corresponding to the original system, e.g. a weapon including recoil or a rescue winch including cable forces.

If tactical operations are to be trained, the use of VR glasses (virtual reality glasses) as a display and the simulation of the systems as a simplified MMI are known. Both the cabin and also the equipment to be operated, e.g. a weapon, are simulated virtually and represented in the VR glasses.

Whereas with the first solution a real system is advantageously physically simulated, the virtual second solution can be implemented at an attractive price. If head-mounted displays with partly transparent displays (see-through technology) are used as VR glasses, then the systems and the crew members can also be seen.

However, the training room, i.e. the simulated cabin, is also to be seen. In addition there can be visual artifacts caused by incorrect overlays of the masked windows or openings for the external view and the crew members present.

The object of the invention is to provide a simulator that provides the advantages of both systems.

According to the invention, this object is achieved with a simulator according to independent claim 1. Advantageous developments of the simulator arise from the dependent claims 2-13.

The simulator according to the invention comprises a training room, whose inner delimiting surface is provided with a color which is suitable for chroma keying. Said simulator comprises at least one partially transparent head-mounted display (HMD), which is provided with two video cameras for stereoscopic images and a head tracker, which enables the determination of the direction of view of the respective wearer. The simulator further comprises a simulation computing unit with two image generators for a stereoscopic illustration of virtual images on the at least one head-mounted display, wherein the illustrated virtual images are generated by a video mixer, which comprises means for the simultaneous mixing of the images of the video camera of the at least one head-mounted display with computed virtual images in the respective viewing direction. The video mixer thus enables the images of the video camera of a display to be simultaneously mixed with a computed virtual scenario and a team member to be given his individual view of the scenario using the blue-box technique. The two image generators thereby enable a different representation for each eye of a person.

The simulator according to the invention is suitable for training at least one person, wherein however, a plurality of persons are preferably trained in the training room at the same time. Therefore the simulator can comprise at least two partially transparent head-mounted displays, on which virtual images can be simultaneously generated for each person by the simulation computing unit. Each team member to be trained receives a head-mounted display, each of which is provided with two video cameras for stereoscopic images and a head tracker, which enables determination of the direction of view of the relevant wearer. The two image generators of the simulation computing unit generate a stereoscopic illustration of the scenario for each display and thus for each team member from the individual viewing direction of the person.

The illustration on the display of a team member is provided by an image of the space from the perspective of the team member being initially recorded with the video camera. Said image consists of the images of the real objects that are disposed in front of the blue screen of the blue box and the remaining areas, which are in the encoded color. At the same time a virtual scene of the training room is generated corresponding to the viewing direction determined by the head tracker. For the areas in the encoded color the corresponding virtual scene is overlaid using the video mixer. The real objects and persons are retained thereby. An image is represented on the display for the team member in training, which is a combination of a virtual scene with embedded real existing persons or objects.

The invention thus combines a blue-box method with the use of partially transparent head-mounted displays, which use a so-called video see-through technology. Thus the trainees can not only see the system surrounding them, which is simulated by the blue-box technique, but the persons can also see other persons and can train with them on common operations. This has the great advantage that real objects that are present can also be represented in a virtual environment and training can be given in their operation. Thereby even one's own hands can be observed and controlled when operating equipment. Thus the advantages and strengths of the so-called augmented virtual reality in a simulator can be used for training persons.

In particular, the trainees can be members of a helicopter crew that operate in the cabin (Helicopter Rear Cabin Crew—H/C Crew). Typically, such a team consists of up to four persons or military personnel, wherein three machine gunners and a flight engineer or a crew chief are provided. E.g. a rescue winch (winch man), the external load procedure and the area of a flight security soldier (door gunner) are to be simulated. Training in such a simulator is at least to be given in the safe operation of the systems (weapon and winch) and the effective and safe use of the systems in action. The individual working areas and training objects can thereby be brought together and used in a simulator, but separate training can also be given.

In the blue-box method a virtual scene is computed on e.g. a blue background. Said virtual scene would be in this case the H/C cabin and the overflown terrain to be seen through the doors and windows or even the cockpit. The blue colored training room is the required background here. To give a blue background from the individual perspectives of the crew members, the HMDs are provided with digital video cameras. The image recorded by the camera is overlaid on the recorded blue areas with a virtual scene from the same angle of view.

Visual artifacts in the form of incorrect overlays are not to be expected, because the crew members present cover the blue background. If the process takes place in real time, the crew members can not only see themselves, but they can also interact directly with each other, wherein this takes place in a virtual and flexibly configurable environment.

In one exemplary embodiment of the invention the entire training room is movably implemented in space, so that maneuvers e.g. of a helicopter can be transferred to the cabin with a motion system. Vibrations can likewise be transferred to the floor of the cabin and thus to the crew in training. It can be advantageous thereby to decouple the floor from the side walls of the training room in order to be able to avoid disadvantageous effects of the vibrations on the blue-box method.

In principle the combination of real and virtual information enables any real existing objects to be integrated into the virtual training environment. Also a trainee is enabled to see themselves, because he/she is likewise recorded by the video camera and becomes a real existing component of the virtual training environment. Real existing persons and pieces of equipment can thus be embedded in a virtual environment.

In one exemplary embodiment of the invention the training room thus comprises at least one training object on which a person is to be trained. The training object can e.g. be a weapon and/or a winch, in each case an original or a model. In the case of a winch the cable of said winch can be coupled to a motion plate, which is movable in two directions within a plane, wherein the motion plate can be controlled by the simulation computing unit. Thus the pendulum motion of a load on the cable can be detectably simulated.

The motion plate can furthermore comprise at least one sensor, with which the force transfer from a person to the cable of the winch can be detected and can be transmitted to the simulation computer unit. Force transfers by a person can thus be taken into account by the simulation, whereby the operator of the winch can influence the pendulum motion by his own force.

In one exemplary embodiment of the invention the cable runs between two reels, onto which the cable can be reeled and from which it can be unreeled. Said reels are preferably located outside the training room and are used to make the reeling in and unreeling of the cable detectable in the palms of the operator.

In order to make the training objects usable as real working models, parts of a training object can be provided with the same color as the inner delimiting surface of the training room for chroma keying. Thus said parts of the training object can be simplified by merging a visual virtual illustration of the respective training object into the scene instead.

For a weapon the simulation computing unit can further comprise means for the calculation and illustration of a sighting point in the virtual images represented on a head-mounted display. Thus e.g. a red dot can be merged in. For a recoil simulation the model of the weapon can comprise a recoil system operated with CO₂ or operated electrically. In this way the recoil of the weapon can be simulated realistically.

With the invention a simulator can be provided that enables, as a crew-compatible training means, both training in handling the systems and also training in tactical operations. The advantages of various technologies can thereby be suitably combined, whereby e.g. the crew of a helicopter can be provided with common and highly realistic training that is inexpensive at the same time. The training room is hereby a “blue platform” in which persons can be trained together in a virtual cabin, whereby previous problems can be avoided. In particular, no cost-intensive training means have to be designed and no compromise has to be made with regards to training contents. Complex illustration systems are avoided, which contributes to the reduction of the production costs. The wishes of individual customers can also be taken into account in a simplified manner and training rooms can be easily exchanged.

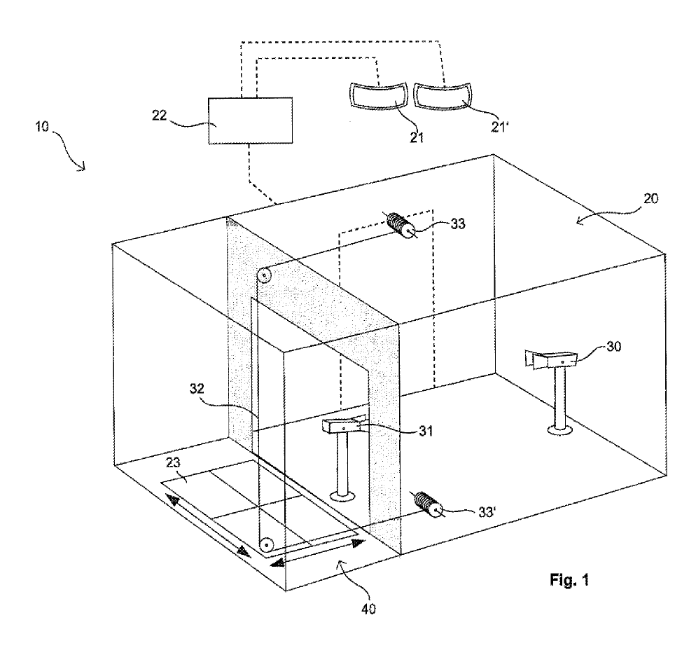

Further advantages, features and advantageous developments of the invention arise from the dependent claims and the following illustration of preferred exemplary embodiments using the illustration in FIG. 1.

FIG. 1 shows in schematic form an exemplary embodiment of the simulator 10 according to the invention with a training room 20. Using this exemplary embodiment the invention is described in detail below as a trainer for training the rear cabin crew of a helicopter (H/C). It can also advantageously be modified and used for the training of crews for military or civil land vehicles, waterborne vehicles, of aircraft crews, of security personnel, for the training of operating crews for operation and emergencies in machine rooms etc.

Realistic (basic) training on the systems, whether it is the machine guns or the rescue winch, requires simulations of said systems that are highly accurate to the original, which should behave essentially the same, if not actually being identical. It is desirable to expand said training for the cooperation of the crew members during a common operation, thus a common training room is added. In this case the training room 20 is thus the simulation of an H/C rear cabin.

For the H/C cabin it is not absolutely necessary to have a physical replica of the helicopter version to be simulated. The cabin is only the shell and at the same time a type of screen, so that the inner delimiting surface of the training room 20 is preferably completely provided with one color that is suitable for chroma keying and thus enables individual regions to be masked out using the blue-box technique. The color blue has proved to be advantageous for this purpose. The virtual illustration of the simulated cabin is projected onto the screen thus formed by means of the blue-box method. In order to be able to display the shell/cabin in its dimensions independently of the H/C cabin, it can be provided that there are no corners and edges and the floor of the cabin should likewise be colored blue.

The visual system consists of two basic components, namely the image generator and the display media. The design of the image generators is independent of the basic concept and is implemented in a simulation computing unit 22, which calculates the desired virtual scenario and transmits it to the display media and the real components of the training room 20.

In contrast, a partially transparent head-mounted display (HMD) with a video see-through function forms the cornerstone of the invention, so that the simulator comprises at least one HMD 21, 21′, which is connected to the simulation computing unit 22 in order to send data to it and to receive data. So that a blue background is thus achieved from the individual viewing angles of the crew members, each HMD is provided with two digital video cameras that transmit their video data to the simulation computing unit 22. In order to determine each respective viewing angle of a person, each HMD is further equipped with a head tracker, which likewise transmits its data to the simulation computing unit 22. Said information is processed by the simulation computing unit 22 and the acquired images are then superimposed on the recorded blue surfaces with a virtual scene from the same viewing angle by transmitting corresponding data from the simulation computing unit 22 to the HMDs.

Preferably, the training room 20 is freely movable in space in order to be able to simulate maneuvers of the cabin. For this purpose a motion system can be provided, which advantageously has six degrees of freedom (DOF). Vibrations can also be transferred to the floor of the cabin.

The rescue winch, the external load procedure and the area of the on-board security soldiers are preferably simulated as working positions. E.g. two weapons 30, 31 are provided in the training room 20 for this purpose, which are in the form of models (mock-ups). The following functions/properties can thereby be simulated: operation, ballistics, cadence, recoil and weight.

The weapon 30, 31 of the machine gunners is preferably a combination of a 1:1 replica and a simplified mock-up. The handles can be implemented as highly realistic copies of the original, thus the operation of the weapon including reloading, releasing the safety catch and firing can be trained. The feel thus corresponds to the original equipment. The orientation of the mock-up is determined by means of dedicated position sensors and passed on to the simulation computing unit 20.

The barrel and the mount of a weapon 30, 31 can advantageously be simplified. Insofar as they are simulated, they should then be colored in the same color (e.g. blue) as the entire cabin 20 in order to be able to merge a virtual illustration of the relevant weapon into the scene. The virtual illustration of the weapon is thereby a photorealistic 3D model. Said 3D model is superimposed on the mock-up and expands the same with e.g. a realistic barrel and sight.

Sighting with a red laser dot can likewise be implemented within the simulated scene. This takes place within the image generator of the simulation computing unit 22 by extending the weapon direction with an imaginary line, determining a common intercept point with the terrain and illustrating a light dot there. For recoil simulation the mock-up has an electrically operated or CO₂ operated recoil system. Said recoil simulation is fast enough to represent the specified cadence, wherein it is strong enough at the same time to simulate recoils. The weight of the weapon and its distribution can be replicated with suitable balancing weights or a force simulation by means of a control load system (CLS).

Furthermore a rescue winch, which likewise is in the form of a model, is provided in the training room 20. The winch is operated or controlled by means of the rescue hoist remote control unit and the following functions are simulated thereon: operation, pendulum motion and reeling in/reeling out.

The pendulum motion of the load is detectably simulated on a cable 32 of the rescue winch by means of an X/Y motion plate 23. Said motion plate 23 is preferably disposed in an upstream shell 40, in which the mechanism for the rescue winch is accommodated. This region is likewise colored blue. While the upper end of the cable 32 is disposed at a fixed point, the lower end of the cable can move. The pendulum motion of a simulated load is thereby converted by the simulation computing unit 22 into a relative X/Y coordinate (0, 0 in the stable rest position) and is transferred to the motion plate 23 at the cable end, the motion plate being provided with positioning motors. Sensors on the axes of the X/Y plate further enable an operator's force to be transferred to the cable 32, and it is transmitted in turn to the simulation computing unit 22.

The reeling out and reeling in of the cable 32 should likewise preferably be detectable in the palms. For this purpose the cable 32 is reeled out as with a real winch from a first reel 33 and at the same time is rolled up onto a second reel 33′ at the lower end, wherein its direction can be changed in between using two rollers. The two reels are thereby advantageously disposed outside the cabin, wherein one reel 33 is attached above the cabin, whilst the other reel 33′ is disposed beneath the cabin. This also allows the cable tension to be simulated, which changes when the load is set on the ground. The “reeling in” can also be simulated at times at which the operator pulls on the cable by asymmetrical reeling in and unreeling of the cable 32. This relates to the possibility of pulling the cable into the cabin, but not to applying or removing a load.

The training environment for the external load procedure is practically a component of the equipment of the door gunner or of the winch man. A machine gunner or flight engineer or crew chief equipped with an HMD can observe the external load during the external load procedure both through a simulated hatch and also through the represented windows and doors of the H/C cabin. He is in communication with the trainer during this and can pass information or commands to him if applicable.

### LIST OF REFERENCE CHARACTERS

10 simulator, trainer

20 training room, cabin, virtual H/C cabin

21, 21′ head-mounted display, HMD

22 simulation computing unit

23 motion plate

30, 31 training object, weapon

32 cable

33, 33′ reel

40 shell

1. A simulator for the training of at least one person, comprising a training room, whose inner delimiting surface is provided with a color that is suitable for chroma keying, wherein the simulator comprises at least one partially transparent head-mounted display, which is provided with two video cameras for stereoscopic images and a head tracker, which enables determination of the viewing direction of the respective wearer, and the simulator further comprises a simulation computing unit with two image generators for stereoscopic illustration of virtual images on the at least one head-mounted display, and the virtual images to be represented can be generated by a video mixer comprising a means for simultaneous mixing of the images of the video cameras of the at least one head-mounted display with computed virtual images in the respective viewing direction.

2. The simulator as claimed in claim 1, characterized in that the simulator comprises at least two partially transparent head-mounted displays, on which virtual images can be generated by the simulation computing unit at the same time.

3. The simulator as claimed in claim 1, characterized in that the entire training room is implemented so as to be movable in space.

4. The simulator as claimed in claim 1, characterized in that the floor can be decoupled from the side walls of the training room.

5. The simulator as claimed in claim 1, characterized in that the training room comprises at least one real training object.

6. The simulator as claimed in claim 5, characterized in that the training object is a weapon and/or a winch, in each case as an original or a model.

7. The simulator as claimed in claim 6, characterized in that a cable of the winch is coupled to a motion plate that is movable in two directions within a plane, wherein the motion plate can be controlled by the simulation computing unit.

8. The simulator as claimed in claim 7, characterized in that the motion plate comprises at least one sensor, with which the force transfer of a person to the cable of the winch can be detected and can be transmitted to the simulation computing unit.

9. The simulator as claimed in claim 6, characterized in that the cable of the winch runs between two reels, onto which the cable can be reeled and from which it can be unreeled.

10. The simulator as claimed in claim 9, characterized in that the two reels are disposed outside the training room.

11. The simulator as claimed in claim 5, characterized in that parts of a training object are provided with the same color as the inner delimiting surface of the training room for chroma keying.

12. The simulator as claimed in claim 6, characterized in that the simulation computing unit for a weapon comprises means for the calculation and illustration of a sighting point in the virtual images represented on a head-mounted display.

13. The simulator as claimed in claim 6, characterized in that the weapon comprises a recoil system operated with CO₂ or operated electrically for a recoil simulation.
